(19) United States
(12) Patent Application Publication
(10) Pub. No.: US 2012/0028071 A1
(43) Pub. Date: Feb. 2, 2012

(54) WALL FACING PANEL

(76) Inventor: Andrey Vilenovich Lyubomirskiy, Moscow (RU)

(21) Appl. No.: 13/138,820

(22) PCT Filed: Mar. 29, 2010
(86) PCT No.: PCT/RU2010/000142

§ 371 Date: Sep. 29, 2011

(30) Foreign Application Priority Data
Mar. 31, 2009 (RU) 2009111485

(51) Int. Cl. B32B 3/30; B32B 15/00

(52) U.S. Cl. 428/600; 428/172; 428/173

(57) ABSTRACT

A wall facing panel has a metal base and an outer layer, on the front face of which there are convex and/or concave elements making up a design with textured structure; the design formed by the elements features convex elements with a diameter of 0.01 mm to 25 mm and concaves with a width of 0.01 mm to 25 mm and a depth not exceeding 0.95 d where=0.02-5.0 mm, the thickness of the sheet material of the outer layer; the design is formed in conformity with the condition where S_{conv}/S_{conc}=0.05-19.0 where S_{conv} is the combined area of the convex elements, and S_{conc} is the combined area of the concaves, and the textured design has a regular spacing of the convex elements and concaves on the front face of the panel, or a random spacing of the convex elements and concaves, or a mix of regular and random spacing of the convex elements and concaves on the front face of the panel.

This invention is for improvements in or relating to the design of wall facing panels with textured surface and can be used in products designed for both indoor and outdoor wall panelling.

There is the decorative panel [1] which has a metal base and a decorative element in the form of a stencilled printed design with a tin layer in between the metal base and the decorative element; the tin layer can be, for example, anodized coating applied to the metal base, and the area occupied by the decorative coating accounts for 50 percent of the base.

There is also the functional and decorative wall panel [2] consisting of a flat metal sheet base, which is fastened to the wall, affixed with fixture elements to the functional and decorative elements on the outer surface of the wall panel; of the decorative layer on the outer side of the wall panel fastened to the base; and of the elastic padding built into the inner side of the panel; the decorative layer is made of a sheet polymer material; the elastic padding is made of flexible sheet material; in the decorative layer and in the base there are apertures spaced at regular intervals from each other along the vertical and horizontal axes; the fixture elements for the functional and decorative elements have hold-down heads fixed to the inner side of the wall panel; the said apertures have a profile that allows for easy insertion of the head of the fixture element into the front side of the wall panel and for the hold-down of the fixture element by the said head from the inner side of the wall panel; the wall panel is divided into sections that are abutted closely to one another on their flanks during the assembly of the wall panel.

The undesirable feature of the prior art panels [1,2] is their structural complexity caused by the fact that they are not single-layer.

There is the metallic wall panel which is a rectangular metal sheet with its edges deflected along the entire perimeter of the sheet, making an acute angle to its front side with a decorative relief; the decorative relief is made by the rectilinear and/or curvilinear elongated ledges (collars) created by high-pressure treatment of the sheet material and positioned symmetrically to the point of intersection of the diagonals of the front surface; and the height of the elongated ledges is more than the thickness of the metal sheet [3].

The undesirable feature of the aforesaid metallic wall panel is that it has low performance parameters. Indeed, applying high-pressure treatment to the sheet material to create the decorative relief on the front surface of the panel with the height of the elongated ledges bigger than the thickness of the metal sheet puts tight restrictions on the thickness of the metal sheet and the mechanical properties of the material it is made of. To manufacture the prior art metallic wall panel, it is not possible to use high-performance metal sheets with a thickness of over 0.8 mm made of high-strength alloy steel with high anticorrosion properties and mechanical strength.

There is also the metallic wall panel taken as the prior art and having a rectangular aluminium base, on the front face of which there are ledges made of natural stone granules glued to the base.

The undesirable features of the prior art engineering solution are the low durability of the metallic wall panel and its low performance indicators since the prior art engineering solution does not assure the high durability of the metallic wall panel.

Closest to the proposed technical solution in its technical spirit is the prior art metallic wall panel [5] which consists of a stainless-steel metal base with decorative elements on its front face; the decorative elements are made in the form of caves filled with dye of appropriate colour either on a level with or no more than 0.14 mm above the front face level by the powder coating method. (Patent of the Russian Federation No. 66383; IPC E04F 13/12, dated 16 Nov. 2006.)

The prior art technical solution is limited in its use due to the simplified fabrication technology (using the powder coating method for filling the caves with dye either on a level with or no more than 0.14 mm above the front face level) which makes it impossible to achieve high quality and create designs on the product in a wide range of product indicators and ensure that the product possesses high consumer properties.

The technical objective, which is achieved through the implementation of the designed product, is to create a new type of wall panels.

The technical result obtained through the implementation of the designed product is the creation of a dirt-resistant vandal-proof wall panel which could preserve its consumer properties over a longer period of time.

To achieve the said technical result in accordance with the first embodiment, provided is the design of a wall panel with a metal base and an outer layer; on the outer layer there are convex elements and/or concaves making up a textured design pattern; the design pattern created by the said elements contains the convex elements with a width of 0.01 mm to 25 mm across, and the concaves with a width of under 0.95d where d stands for the thickness of the sheet material of the outer layer; the design pattern is created in conformity with the condition where S_{conv}/S_{conc.}=0.05-19.0 where S_{conv.} is the combined area of the convex elements, and S_{conv.} is the combined area of the caves. The outer layer could be made of stainless steel, aluminium alloy, titan and other structurally acceptable materials; specifically, of carbon steel, including zinc-coated carbon steel. In accordance with the preferable embodiment, in case the metal base is made of stainless steel, its thickness would be d=0.1-5.0 mm, and if made of an aluminium alloy, d=0.01-5.0 mm. The design pattern could feature a regular spacing of convex and concave elements on the front face of the panel thus forming an ornament, and randomly spaced convex and concave elements on the front face of the panel thus forming a chaotic design pattern, or a mix of regular and random spacing of convex and concave elements on the front face of the panel thus forming a design pattern that would feature groups of convex and concave elements positioned in between the elements of its ornament.

To achieve the said technical result in accordance with the second embodiment, provided is the design of a wall panel with a metal base and an outer layer; on the outer layer there are convex elements and/or concaves making up a textured design pattern; the design pattern created by these elements contains the convex elements with a width of 0.01 mm to 25 mm, and the concaves with a width of under 0.95d where d=0.02-5.0 mm, the thickness of the sheet material of the outer layer; the design pattern is created in conformity with the condition where S_{conv.}/S_{conc.}=0.05-19.0, where S_{conv.} is the combined area of the convex elements, and S_{conv.} is the combined area of the concave elements, and the concaves are filled with hardened medium.

The outer layer could be made of stainless steel, aluminium composite, titan and other structurally acceptable materials; specifically, of carbon steel, including zinc-coated carbon steel. In case the metal base is made of stainless steel, its preferable width would be d=0.1-5.0 mm, and if made of an aluminium alloy, d=0.01-5.0 mm. The design pattern could feature a regular spacing of convex and concave elements on the front face of the panel thus forming an ornament, and randomly spaced convex and concave elements on the front face of the panel thus forming a chaotic design pattern, or a mix of regular and random spacing of convex and concave elements on the front face of the panel thus forming a design pattern that would feature groups of convex and concave elements positioned in between the elements of its ornament. Polymers, composite materials or dye can be used as hardened medium for filling the concave elements of the textured surface of the panel.

To achieve the said technical result in accordance with the third embodiment, provided is the design of a wall panel with a metal base and an outer layer; on the outer layer there are convex elements and/or concaves making up a textured design pattern; the design pattern created by these elements contains the convex elements with a width of 0.01 mm to 25 mm, and the concaves with a width of under 0.95d where d=0.02-5.0 mm, the thickness of the sheet material of the outer layer; the design pattern is created in conformity with the condition where S_{conv.}/S_{conc.}=0.05-19.0 where S_{conv.} is the combined area of the convex elements, and S_{conc.} is the combined area of the concaves, and the wall panel additionally contains an interlayer created by the hardened material. It is preferable that the interlayer should be formed by hardened adhesive composition. The outer layer could be made of stainless steel, aluminium composite, titan and other structurally acceptable materials; specifically, of carbon steel, including zinc-coated carbon steel. In case the metal base is made of stainless steel, its preferable thickness would be d=0.1-5.0 mm, and if made of an aluminium alloy, d=0.01-5.0 mm. The design pattern could feature a regular spacing of convex and concave elements on the front face of the panel thus forming an ornament, and randomly spaced convex and concave elements on the front face of the panel thus forming a chaotic design pattern, or a mix of regular and random spacing of convex and concave elements on the front face of the panel thus forming a design pattern that would feature groups of convex and concave elements positioned in between the elements of its ornament. Polymers, composite materials or dye can be used as hardened medium for filling the concave elements of the textured surface of the panel.

The said technical result is achieved in the provided wall panel by choosing between the three texture design options:

the texture of the surface features regular concave and convex elements that make up an ornament;

the texture of the surface features random concave and convex elements that make up a chaotic design;

the texture of the surface is a mix of regular and random spacing of the concave and convex elements on the front face of the panel that make up a pattern that features groups of convex and concave elements positioned in between the elements of the ornament.

During the development of the wall panel design, it was experimentally deduced that the width and the depth of the ledges and cavities of the relief-textured design is absolutely crucial for this type of wall panels.

The tests and the research have revealed that the minimum possible width that makes economic sense is 0.01 mm. Further reduction of the width does not make sense because it is difficult for the human eye to discern such small objects. In addition, from the technological point of view, cavities smaller than 0.01 mm can be made by the costly photolithographic technique. The objects larger than 0.01 can be made by the inexpensive techniques like tampon printing.

The use of micro-relief with the indicated dimensions filled with coloured medium (dye, dyed composite) makes it possible to protect the aforementioned coloured medium in the relief cavities from the damage that solid bodies may cause. In this case, the metallic ledges encircling the polymer perform the protective function. The smaller the width of the medium-filled cavity is, the smaller the chances are that the coloured medium will be damaged in the process of use. Usually, in a city environment, vandals use metallic coins, lock keys, less frequently penknives, i.e. the things that every man has at his disposal in public places.

Below are the characteristics of coins:
the ten-kopek coin has a diameter of 17.5 mm and a thickness of 1.1 mm; made from a copper-base alloy;
the fifty-kopek coin has a diameter of 19.4 mm and a thickness of 1.4 mm; made from a copper-base alloy;
the one-rouble coin has a diameter of 20.5 mm and a thickness of 1.3 mm, made from a steel-base alloy;
the two-rouble coin has a diameter of 23 mm and a thickness of 1.8 mm; made from a steel-base alloy;
the two-rouble coin has a diameter of 25 mm and a thickness of 1.8 mm; made from a steel-base alloy;

The analysis of the geometric dimensions and the materials used in the production of the coins shows that the small-denomination coins of 10 and 50 kopeks made from soft copper-base alloys will not cause considerable damage to the decorative coatings of the panels. Moreover, the small size of the coins will not allow a vandal, without devoting a considerable physical effort, to have a firm grip on the coin by his thumb and index finger to ensure a significant part of the coin protrudes from in between the fingers. However, a vandal can easily have a firm grip on the coins with denominations of 1, 2 and 5 roubles between his fingers, in particular the five-rouble coin which has a diameter of 25 mm and a thickness of 1.8 mm.

During the testing of the relief characteristics, experiments were conducted with textured-surface sheet materials; the textured surface featured convexes and concaves, with the concaves filled with polymer powder paints based on the epoxy resin [symbol] [symbol] -20 with a curing temperature of around 200° C. in the oven for five minutes. The width of the cavities in the relief used in the test varied from 0.01 mm to 50 mm. The relief cavities were either fully or half filled with the hardened dye. The force applied to the coin was within the range of 5 to 10 kg. The generatrix of the coin had a knurled profile.

Taking into account that the dye has a certain hardness which depends on the chemical composition of the binding agent (epoxide, polyester, polyurethane), it is evident that the value of resistance to the process of cutting of the surface by the coin changes. Moreover, the composition of dyes often includes fillers such as glass micro powder which have a high hardness value. In addition, the fact was taken into consideration that not all vandals can scratch the surface of a panel by a blunt coin for a long time, because it requires a strenuous physical effort. There is a need to bear in mind that the force of cutting as a coin scratches the cavities of the decorative relief should be huge so as to “get” to the bottom of the dyed cavity (filled with a polymer or a composite).

Numerous experiments conducted with the five-rouble coin have revealed that the biggest permissible width of the relief is 25 mm.

In other words, the optimal width of the cavity filled with dye is within the range of 0.01 mm to 25 mm.

In addition, it should be noted that the wall panel has another important consumer feature, which is that scratches are unnoticeable.

During the course of tests, it has been proved that a scratch on the dyed metal becomes noticeable when there appears a sharp contrast between the dyed and the undamaged surface and the gleam of the bear metal surface. If as a result of an act of vandalism a gleam of bear metal becomes visible on the monotonously dyed surface, a man subconsciously understands that there is a scratch in that place. With a width of less than 25 mm such scratches will be fewer in number as their length is limited to the same 25 mm. If scratches do appear, these will not be lines but rather barely visible specks instead.

In addition, the coating itself is an interlacing (from the point of view of the observer who does not have the knowledge of the composition and structure of the coating) of dyed and non-dyed patches some of which have a certain colour. All other patches are gleams of the metal surface and, above all, stainless steel. For a lay observer without special optical tools, it would be difficult to discern whether a gleam comes from an non-dyed patch, a ledge of the decorative relief or from a small scratch in the relief cavity which appeared as a result of an act of vandalism.

With a width of the relief elements ranging between 0.1 mm to 25 mm, fingerprints become invisible as well; fingerprints are one of the most common causes of dirt smearing a polished surface.

With the given width of the relief, it is easy to clear it of dust and other types of dirt.

The following are the important factors that influence the depth of the relief: the quality of the coloured relief filler to hide the metal surface (to ensure the metal surface does not shine through the layer of the coloured filler). During the course of tests, it has been found that you can use a flat layer of the coloured filler with a thickness of 20-200 micron;

under the impact of sun rays and above all ultraviolet, the relief filler—the dye—becomes less thick due to the destruction of the colouring agent's molecules and sublimation of the results of destruction of macromolecules.
reducing the depth of relief while preserving the performance characteristics of the wall panel makes it possible to reduce the thickness of the panel, which leads to a reduction of its cost due to the decrease in the mass of the material, simplification of the panel fabrication technology, and the fact that it becomes easier to fasten the panel to the wall.
the dimensions of the fillers of the coloured matter. It has been found in the course of tests that the depth of the relief should be between 2 to 4 times more than the diameter of the biggest particle of the filler.

Taken the aforementioned into account, a series of experiments was conducted which revealed that the relief depth must not exceed the value of 0.95d where d stands for the thickness of sheet material.

The experiments to study the discernibility of scratches, fingerprints and to clean the surface have showed that a decorative design must be made in accordance with the following condition: S_{conv.}/S_{conc.}=0.05-19.0 where S_{conv.} is the combined area of the convex elements, and S_{conc.} is the combined area of the concaves, with the metal base having a thickness of d=0.1-5.0 mm.

The spirit of the invention of the provided wall facing panel is illustrated in the drawings:

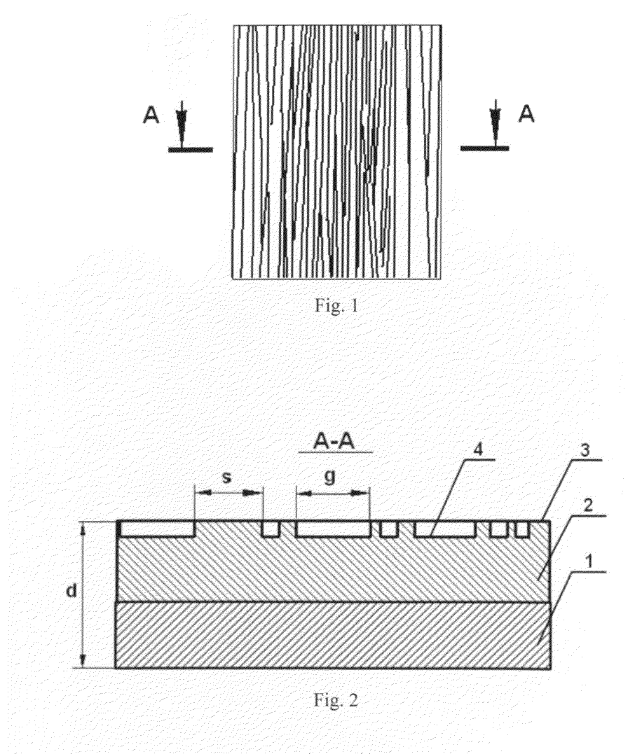

FIG. 1 shows a fragment of the metallic wall panel; view of the side of its front face;

FIG. 2 shows the cross-section along the panel A-A showed in FIG. 1;

FIG. 3 shows the relief design on the front face of the wall panel following the first design option;

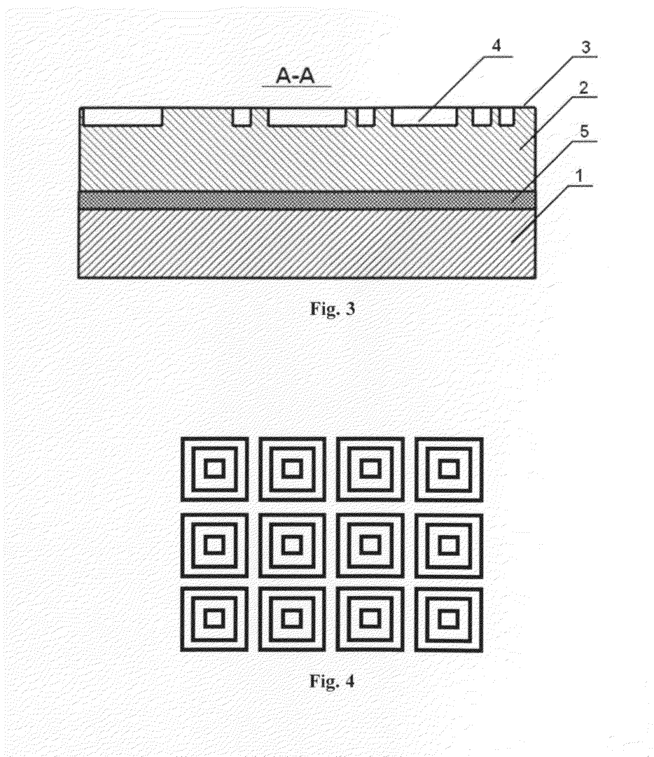

FIG. 4 shows the relief design on the front face of the wall panel following the first design option;

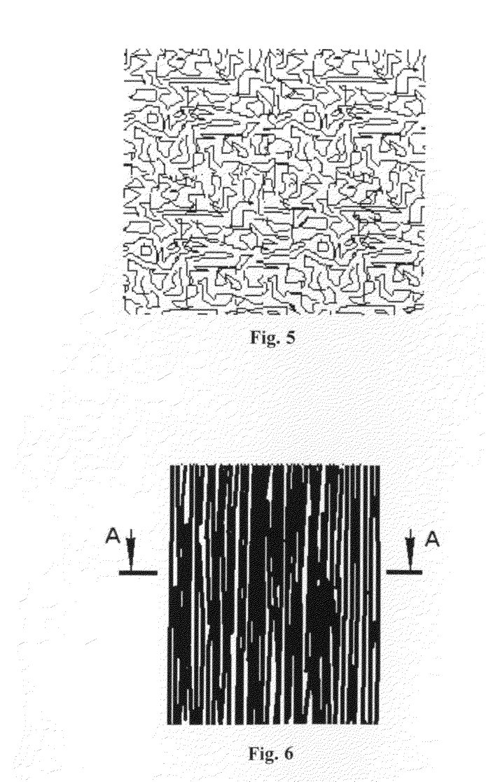

FIG. 5 shows the relief design on the front face of the wall panel following the first design option;

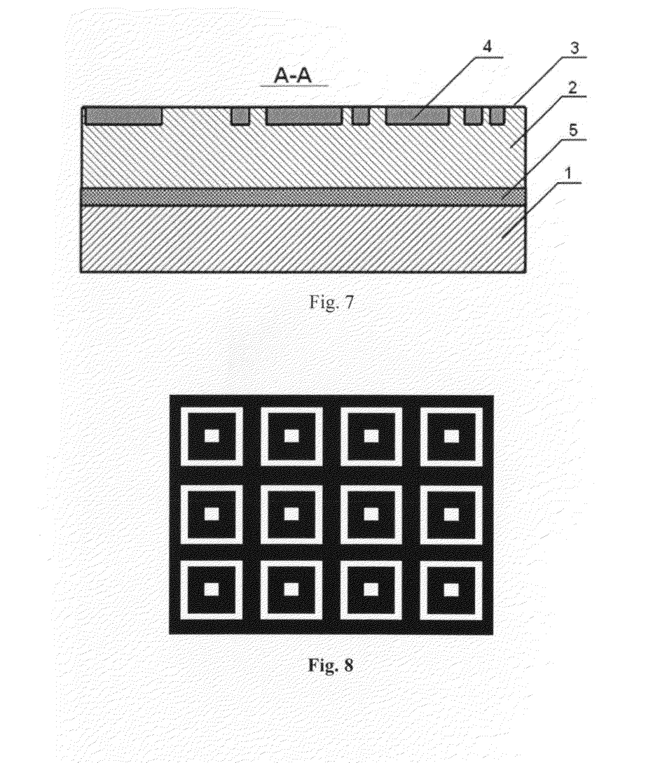

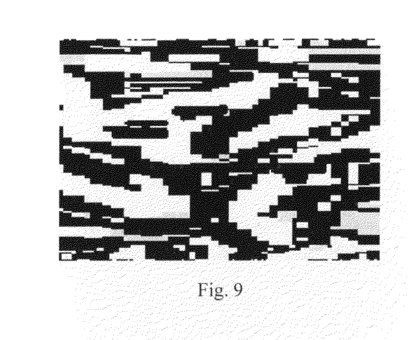

FIG. 6-9 shows the drawings of the relief profiles filled with dye.

The wall facing panel (FIG. 1, FIG. 2) consists of the base 1 and the outer layer 2.

The convex elements 3 have a diameter ranging from 0.01 mm to 25 mm, and concaves 4 have a width ranging from 0.01 mm to 25 mm and a depth under 0.95d where d stands from the thickness of sheet material; the decorative design is made in accordance with the condition: S_{conv.}/S_{conc.}=0.05-19.0 where S_{conv.} is the combined area of the convex elements, and S_{conc.} is the combined area of the concaves.

The said ratios of the geometric parameters of the convex and concave elements make it possible to create relief designs (from simple designs and ornaments to complex drawing-type designs), thus making it possible to expand the area of use of the proposed wall facing panel.

The provided wall panel is fabricated as follows:

The metal base 1 (FIG. 1) is made of stainless steel with a thickness of d=0.1-5.0, or of an aluminium alloy with a thickness of d=0.01=5.0, or of zinc-coated carbon steel.

The outer decorative layer 2 is made of stainless steel with a thickness of d=0.02-5.0 mm.

The metal base 1 can be fastened to the outer layer 2 by gluing them together, for example, using appropriate adhesive compositions 5.

A relief design with the indicated geometric parameters can be made, for example, by chemical etching; prior to etching, a protective mask must be applied using the template web printing technique; the patches unprotected by the mask are exposed to the impact etching solution; as a result, a relief design is created in the metal tape with the concaves etched to the aforementioned value.

Then, the concaves of the relief design are filled with dye which hardens over time; ultraviolet and/or infrared radiation is used, if necessary.

The design is created in conformity with the following condition: S_{conv.}/S_{conc.}=0.05-19.0 where S_{conv.} is the combined area of the convex elements, and S_{conc.} is the combined area of the concaves.

The indicated ratios of the parameters obtained as a result of a series of lengthy experiments make it possible to create relief designs of virtually any complexity (see FIG. 3-FIG. 5). Thus, the design features distinguishing the provided wall panel from the prior art are dependant, through the relation of cause and effect, on the attainable technical result, which is the creation of a dirt-resistant vandal-proof wall panel which could preserve its consumer properties over a longer period of time.

The fastening of the panel to the surface that needs panelling is done by the prior art methods: the panels are glued using an adhesive composition or fastened by fixture elements.

The outer layer of the wall panel is to be fabricated preferably from stainless steel (brands X18H25C2, X18H9, 08X18H10, 08X18H9T, 12X18H9, 12X18H9T, and others) with a thickness between 0.03 to 3.0 mm.

The metal base is made preferably of stainless steel of the aforementioned brands with a thickness of d=0.1-5.0, or of an aluminium alloy or a sheet of aluminium alloys of the brands AK-1, AJI-7, AJI-8, AJI-9 with a thickness of d=0.01=5.0, or of carbon steel or zinc-coated carbon steel.

The materials used in this wall panel are highly resistant to external impact and ensure a long operating life of the product.

### INFORMATION SOURCES

1. Patent of the Russian Federation No. 2780, IPC B44C 5/04, 1995.
2. Patent of the Russian Federation No. 54338, IPC B44F 5/00, 2006.
3. Patent of the Federal Republic of Germany No 2903359, IPC B44F, B44C1980/04, 1980.
4. Patent of the Federal Republic of Germany No. 3929761, IPC B44F, 1991.
5. Patent of the Russian Federation No. 66383; IPC E04F 13/12, 2006

1-39. (canceled)

40. A wall panel, comprising a metal base and an outer layer, on a front face which there are elements selected from the group consisting of convex elements, concave elements and both making up a design with textured structure wherein the design formed by the elements includes the convex elements with a diameter of 0.01 mm to 25 mm and the concaves with a width of 0.01 mm to 25 mm and a depth not exceeding 0.95 d where d=0.02-5.0 mm is a thickness of a sheet material of the outer layer, wherein the design is formed in conformity with a condition where S_{conv.}/S_{conc.}=0.05-19.0 where S_{conv.} is a combined area of the convex elements and S_{conc} is a combined area of the concaves.

41. The wall panel as defined in claim 40, wherein the outer layer is composed of a material selected from the group consisting of aluminum alloy, and titan.

42. The wall panel as defined in claim 41, wherein the metal base is composed of a material selected from the group consisting of stainless steel with a thickness of d=0.1-5.0 mm, and aluminum alloy with a thickness of d=0.1-5.0 mm.

43. The wall panel as defined in claim 40, wherein the metal base is composed of a material selected from the group consisting of carbon steel and zinc-coated carbon steel.

44. The wall panel as defined in claim 40, wherein the design features have a spacing selected from the group consisting of regular spacing of the convex elements and concaves on the front face of the panel thus producing an ornament, random spacing of the convex elements and concaves on the front face of the panel thus producing a chaotic design pattern, and a mix of regular and random spacing of the concave and convex elements on the front face of the panel, which forms a design pattern with groups of convex and concave elements positioned in between the elements of the ornament.

45. A wall panel, comprising a metal base and an outer layer, on a front face of which there are elements selected from the group consisting of convex elements, concave elements and both making up a design with textured structure, wherein the design formed by the elements includes the convex elements with a diameter 0.01 mm to 25 mm and the concaves with a width of 0.01 mm to 25 mm and a depth not exceeding 0.95 d where d=0.02-5.0 mm is a thickness of the sheet material of the outer layer; wherein the design is formed in conformity with a condition where S_{conv}/S_{conc}=0.05-19.0 where S_{conv} is a combined area of the convex elements, and S_{conc} is a combined area of the concave elements, and the concaves are filled with hardened medium.

46. The wall panel as defined in claim 45, wherein the outer layer is composed of a material selected from the group consisting of stainless steel, aluminum alloy, and titan.

47. The wall panel as defined in claim 45, wherein the metal base is composed of a material selected from the group consisting of stainless steel with a thickness of d=0.1-5.0 mm, and aluminum alloy with a thickness of d=0.12-5.0 mm.

48. The wall panel as defined in claim 45, wherein the metal base is composed of a material selected from the group consisting of carbon steel, and zinc-coated carbon steel.

49. The wall panel as defined in claim 45, wherein the design features has a spacing selected from the group consisting of a regular spacing of the convex elements and concaves on the front face of the panel thus producing an ornament, a random spacing of the convex elements and concaves on the front face of the panel thus producing a chaotic design pattern, and a mix of regular and random spacing of the concave and convex elements on the front face of the panel, which forms a design pattern featuring groups of convex and concave elements positioned in between the elements of the ornament.

50. The wall panel as defined in claim 45, wherein a material selected from the group consisting of a hardened medium, a composite material, and a dye is used as a hardened medium for filling the concaves of a relief.

51. A wall panel comprising a metal base and an outer layer, on a front face of which there are elements selected from the group consisting of convex elements, concave elements and both making up a design with textured structure, wherein the design formed by the elements includes convex elements with a diameter of 0.01 mm to 25 mm and concaves with a width of 0.01 mm to 25 mm and a depth not exceeding 0.95 d where d=0.02-5.0 mm, which is a thickness of a sheet material of the outer layer; and wherein the design is formed in conformity with a condition where S_{conv.}/S_{conc}=0.05-19.0 where S_{conv.} is a combined area of the convex elements, and S_{conc} is a combined area of the concaves, and the wall panel additionally contains an interlayer created by a hardened material.

52. The wall panel as defined in claim 52, wherein the interlayer is of a hardened adhesive composition.

53. The wall panel as defined in claim 52, wherein the outer layer is composed of a material selected from the group consisting of stainless steel, aluminum alloy, and titan.

54. The wall panel as defined in claim 51, wherein the metal base is composed of a material selected from the group consisting of stainless steel with a thickness of d=0.1-5.0 mm, aluminum alloy with a thickness of d=0.26-5.0 mm, carbon steel, and zinc-coated carbon steel.

55. The wall panel as defined in claim 51, wherein the elements have a spacing selected from the group consisting of a regular spacing of the convex elements and concaves on the front face of the panel thus producing an ornament, a random spacing of the convex elements and concaves on the front face of the panel thus producing a chaotic design pattern, and a mix of regular and random spacing of the concave and convex elements on the front face of the panel, which forms a design pattern featuring groups of convex and concave elements positioned in between the elements of the ornament.

56. The wall panel as defined in claim 51, wherein a material selected from the group consisting of polymers and a composite material is used as a hardened medium for filling the concaves of the relief.
